(19) United States
(12) Patent Application Publication
(10) Pub. No.: US 2014/0073740 A1
(43) Pub. Date: Mar. 13, 2014

(54) THERMOPLASTIC ELASTOMER COMPOSITION AND ARTICLE MADE THEREFROM

(71) Applicants: Jonathan W.J. LIN, Changhua (TW); Ping-Huang CHEN, Changhua (TW); Wun-Sheng WU, Changhua (TW)

(72) Inventors: Jonathan W.J. LIN, Changhua (TW); Ping-Huang CHEN, Changhua (TW); Wun-Sheng WU, Changhua (TW)

(73) Assignee: LI PENG ENTERPRISE CO., LTD., Taipei City (TW)

(21) Appl. No.: 13/613,194

(22) Filed: Sep. 13, 2012

(51) Int. Cl. C08L 51/00; C08L 67/03; C08L 77/00

(52) U.S. Cl. 525/66

(57) ABSTRACT

The present invention relates to a thermoplastic elastomer composition, including an elastomer and a thermoplastic component having polyamide, polyethylene terephthalate and a compatibilizer. This present invention also relates to a thermoplastic elastomer article in which a hard thermoplastic matrix is made of a thermoplastic component that includes polyamide, polyethylene terephthalate and a compatibilizer, and soft elastomeric domains distributed within the hard thermoplastic matrix and made of an elastomer.

### BACKGROUND OF THE INVENTION

1. Field of the Invention

The present invention is directed to a thermoplastic elastomer composition, specifically a thermoplastic elastomer composition comprising an elastomer and a thermoplastic component. This invention also relates to a thermoplastic elastomer article having a hard thermoplastic matrix and soft elastomeric domains distributed within.

2. Description of the Related Art

Elastic materials are formed by cross-linking of long polymer chains of a natural or synthetic rubber through vulcanization, i.e., addition of sulfur to the natural or synthetic rubbers. The elastic materials thus formed have viscoelasticity property when undergoing deformation.

The vulcanized elastic materials possess good wearing ability, elasticity and softness, which make it suitable as the main material for tires. However, the vulcanized elastic materials have unsatisfactory tensile yield strength, heat deflection temperature and aging properties. For example, styrene-butadiene rubber has tensile yield strength of approximately 45 MPa, heat deflection temperature of approximately 40° C. and impact strength of approximately 60 J/m. In addition, uneven distribution of sulfur in natural rubber is commonly seen, and slow vulcanization process for synthetic rubbers has yet to be overcome.

US 2004171750 A1 discloses a thermoplastic elastomer composition mainly composed of isobutylene polymer and olefinic resin with the addition of a cross-linking agent. The thermoplastic elastomer made from the thermoplastic elastomer composition provides good elasticity. However, the method for producing the thermoplastic elastomer composition is relatively complicated, which involves the synthesis of polystyrene-polyisobutylene-polystyrene triblock copolymer followed by the polymerization of the triblock polymer and olefin resin via a melt-kneading step.

Accordingly, there is a need in the art to develop a thermoplastic elastomer composition and a thermoplastic elastomer article that does not require vulcanization yet is simple to manufacture with the desired properties of vulcanized elastomers.

### SUMMARY OF THE INVENTION

Therefore, according to the first aspect of this invention, a thermoplastic elastomer composition is provided, which comprises an elastomer and a thermoplastic component including polyamide, polyethylene terephthalate and a compatibilizer.

In the second aspect of this invention, a thermoplastic elastomer article is provided, which comprises a hard thermoplastic matrix made of a thermoplastic component that includes polyamide, polyethylene terephthalate and a compatibilizer, and soft elastomeric domains distributed within the hard thermoplastic matrix and made of an elastomer.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view illustrating the preferred embodiment of a thermoplastic elastomer article of the present invention, and a cross sectional view illustrating soft elastomeric domains distributed within a hard thermoplastic matrix; and

FIG. 2 is a schematic diagram showing an extruding machine for the production of a thermoplastic elastomer. The extruding machine has a blending zone with six heating areas.

### DETAILED DESCRIPTION OF THE PREFERRED EMBODIMENTS

A thermoplastic elastomer composition of the preferred embodiment of the present invention includes an elastomer and a thermoplastic component including polyamide, polyethylene terephthalate (PET) and a compatibilizer.

The polyamide and polyethylene terephthalate (PET) included in the thermoplastic component are both high polar polymers, and have low compatibility with non-polar molecules, such as polyolefine elastomers including ethylene propylene copolymer rubber (EPR), ethylene propylene diene terpolymer (EPDM), etc. The low compatibility can be resolved by addition of maleic anhydride. Thus, preferably, the elastomer comprises maleic anhydride grafted elastomer. Active acid anhydride moieties on the elastomer can be bonded to the amino groups from polyamide or hydroxyl groups from PET. A thermoplastic elastomer article made from the aforementioned composition exhibits good elasticity and does not require any vulcanization process.

Preferably, the maleic anhydride grafted elastomer is selected from the group consisting of maleic anhydride grafted thermoplastic elastomer, maleic anhydride grafted thermoplastic rubber and maleic anhydride grafted rubber. Examples of the maleic anhydride grafted elastomer include maleic anhydride grafted ethylene vinyl acetate (EVA-g-MAH), maleic anhydride grafted styrene butadiene styrene block copolymer (SBS-g-MAH), maleic anhydride grafted ethylene propylene copolymer rubber (EPR-g-MAH) and maleic anhydride grafted ethylene propylene diene terpolymer (EPDM-g-MAH).

Preferably, the polyamide is Nylon, e.g., Nylon 6.

The physical properties of the thermoplastic elastomer article made from the thermoplastic elastomer composition are determined by the proportion of the elastomer. When the proportion of the elastomer is unduly low, the thermoplastic elastomer article has inferior or no elasticity. When the content of the elastomer is excessively high, arbasion resistance, hardness and dimensional stability of the thermoplastic elastomer article would be decreased. Preferably, the elastomer is present in an amount ranging from 1 wt % to 90 wt % based on the total weight of the thermoplastic component.

The physical properties of the thermoplastic elastomer article are also determined by the proportion of the thermoplastic component. The polyamide has a strong tensile yield strength and endurance, which enables the thermoplastic elastomer article to have better wearing ability. However, the polyamide has low flexural strength and dimensional stability. The addition of PET would enhance flexural strength, dimensional stability and heat deflection temperature.

Moreover, since polyamide and PET are incompatible, the compatibilizer is required to improve the compatibility of the two distinct materials by virtue of balancing the crystallization rate of the two materials. The thermoplastic elastomer article thus obtained has good dimensional stability. Also, the addition of the compatibilizer renders the thermoplastic elastomer article to become soft. Preferably, the compatibilizer is an epoxy polymer, more preferably, an epoxy silane resin or alicyclic type epoxy resin.

Preferably, based on the total weight of the thermoplastic component, the contents of polyamide, PET and compatibilizer are 10 wt % to 85 wt %, 5 wt % to 15 wt %, and 5 wt % to 80 wt % respectively.

A modifier can be added to the thermoplastic elastomer composition to improve the impact strength of the thermoplastic elastomer article under low temperature. Preferably, the modifier is present in an amount ranging from 10 wt % to 70 wt % based on the total weight of the thermoplastic component.

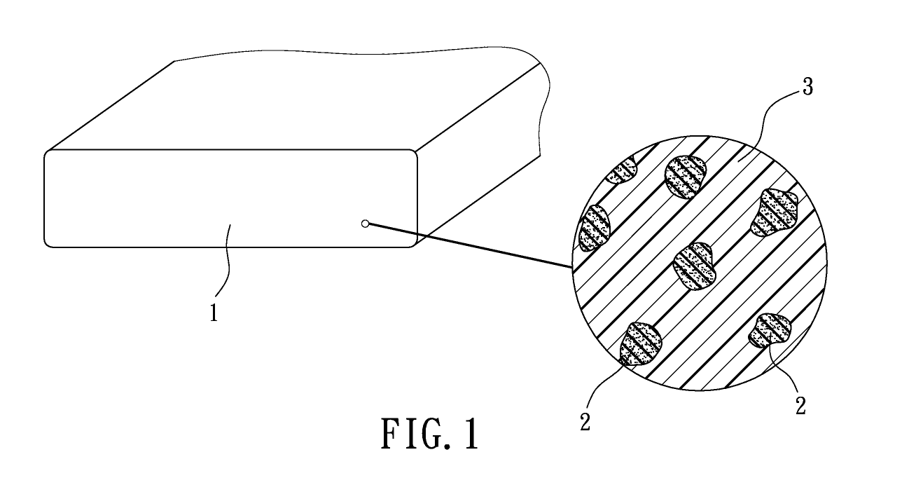

FIG. 1 shows the thermoplastic elastomer article 1 of this invention which comprises a hard thermoplastic matrix 3 that forms a continuous phase, and soft elastomeric domains 2 distributed within the continuous phase of the hard thermoplastic matrix 3. The hard thermoplastic matrix 3 is comprised of polyamide, PET and the compatibilizer, and the soft elastomeric domains 2 are comprised of the elastomer. The soft elastomeric domains 2 are bonded to the hard thermoplastic matrix 3 via chemical bonds formed between the maleic anhydride moieties of the elastomer in the soft elastomeric domains 2 and the amino groups of polyamide and hydroxyl groups of PET in the hard thermoplastic matrix 3.

The thermoplastic elastomer article 1 can be manufactured by hot press, injection or profile extrusion.

### EXAMPLES

This invention will be further described by way of the following examples. However, it should be understood that the following examples are solely intended for the purpose of illustration and should not be construed as limiting the invention in practice.

### <Source of Chemicals>

1. Nylon 6: Mw: 16,000 to 19,000; obtained from recycled synthetic fabrics from Lipeng Co. Ltd. The methods for extracting nylon can be referred to the examples disclosed in US Patent Publication No. US 2006/0031997 A1, which is hereby incorporated by reference in its entirety.

2. Polyethylene terephthalate (PET): Mw: 200,000; obtained from recycled synthetic fabrics from Lipeng Co., Ltd. The methods for extracting PET can be referred to the examples disclosed in U.S. Pat. No. 4,917,845. The molecular weight of PET is determined by the methods disclosed by Rosano H. L. (Journal of Colloid Science, 10, 4; 362-369, 1955). Both references are hereby incorporated by reference in its entirety.

3. Compatibilizer: silane coupling agent A-187 (KH-560), γ-(2, 3-epoxypropoxy) propyltrimethoxysilane; represented by the following formula (I) and purchased from ThinkBond Chemical Co., Ltd, Chengdu.

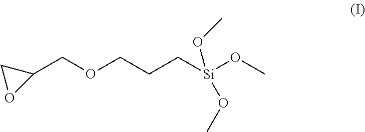

4. Elastomer: maleic anhydride grafted ethylene vinyl acetate (EVA-g-MAH); Mw: 3,000 to 4,000; purchased from Dupont Dow Elastomers L.L.C.

5. Modifier: ethylene octene trepolymer (POE); Mw: 5,000; purchased from Dupont Dow Elastomers L.L.C.

### <Standard Testing Methods>:

Tensile yield strength: determined according to ASTM D638.

Elongation at break: determined in accordance with ASTM D638.

Flexural strength: determined in accordance with ASTM D790.

Flexural modulus: determined in accordance with ASTM D790. The test was stopped when the samples reached 0.3% deflection.

Impact strength: determined in accordance with ASTM D256.

Hardness: determined in accordance with ASTM D2240 (share D).

Deflection: determined in accordance with ASTM D638 under a load of 1.82 MPa at a temperature rise rate of 2° C. per minute. Temperature at 0.25-mm deflection was recorded.

Abrasion resistance (Wearing): a thermoplastic elastomer article sample was held by an inflated diaphragm and abraded against a sandpaper positioned thereabove. The sandpaper was reciprocally moved and the sample was rotating in-place simultaneously. The abrasion resistance was determined in accordance with ASTM D3886.

Linear expansion coefficient: determined in accordance with ASTM D696 in a temperature range from −30° C.˜30° C. A thermoplastic elastomer article sample in this test had a cylindrical shape with 5 mm diameter.

### Example 1

### Nylon 6: PET: Compatibilizer=10:10:80

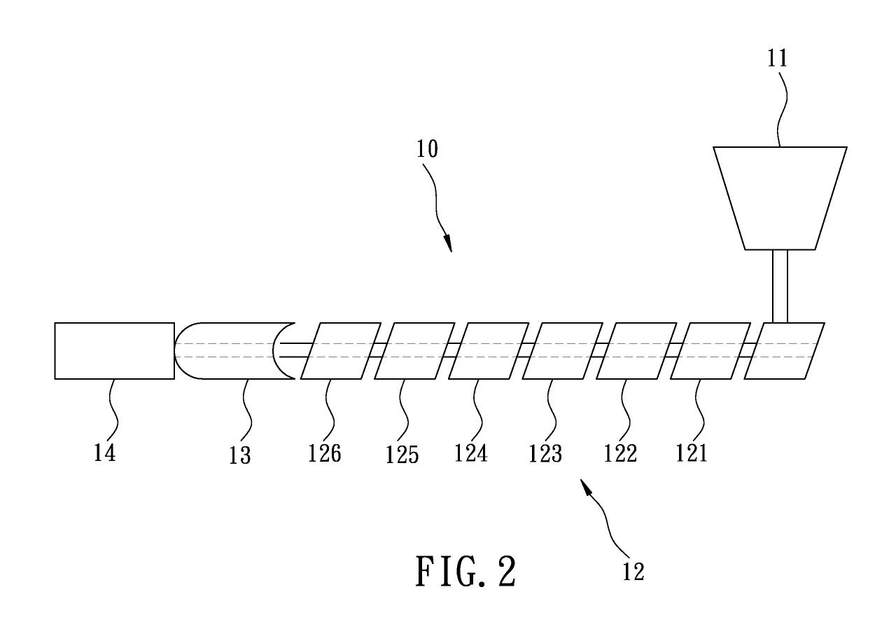

A thermoplastic elastomer article sample was made by blending materials shown in FIG. 2 using a twin-screw extruder 10 (Intermeshing Co-Rotating model, ψ=30 mm, L/D=43.2, purchased from Kobe steel) based on ASTM D638 type I. Specifically, thermoplastic component composed of 10 wt % of Nylon 6, 10 wt % of PET and 80 wt % of compatibilizer was blended in the twin-screw extruder 10 with 1 wt % of EVA-g-MAH and 10 wt % of POE, each of which is based on the total weight of the thermoplastic component. As shown in FIG. 2, the materials were fed into an inlet 11 of the twin-screw extruder 10 and blended in a blending zone 12 having six heating areas 121, 122, 123, 124, 125, 126.

The blended composition was extruded from an outlet 13 to a die 14 so as to obtain a thermoplastic elastomer article sample. Preferably, the speed of the twin-screw extruder 10 was 20 rpm to 100 rpm. The operating temperatures in the six heating areas 121, 122, 123, 124, 125, 126 were 230° C. to 250° C., 240° C. to 260° C., 250° C. to 270° C., 255° C. to 275° C., 250° C. to 270° C., and 240° C. to 260° C., respectively. The operating temperature of the die 14 was 90° C. to 100° C. In this embodiment, the speed of the twin-screw extruder 10 was 60 rpm, the operating temperatures in the six heating areas 121, 122, 123, 124, 125 and 126 were 240° C., 250° C., 260° C., 265° C., 260° C. and 250° C. respectively, and the operating temperature of the die 14 was 80° C.

The thermoplastic elastomer article sample thus obtained was subjected to the following tests: tensile yield strength, elongation at break, flexural strength, flexural modulus, impact strength, hardness, heat deflection temperature, abrasion resistance, and linear expansion coefficient. The results are shown in Table 1.

### Example 2

### Nylon 6: PET: Compatibilizer=30:10:60

The method for making a thermoplastic elastomer article sample of Example 2 was similar to that of Example 1, except that the thermoplastic component was composed of 30 wt % of Nylon 6, 10 wt % of PET, and 60 wt % of compatibilizer, and, based on the total weight of the thermoplastic component, the amounts of EVA-g-MAH and POE were 40 wt % and 30 wt %, respectively. The test results for the thermoplastic elastomer article sample of Example 2 are shown in Table 1.

### Example 3

### Nylon 6: PET: Compatibilizer=60:10:30

The method for making a thermoplastic elastomer article sample of Example 3 was similar to that of Example 1, except that the thermoplastic component was composed of 60 wt % of Nylon 6, 10 wt % of PET, and 60 wt % of compatibilizer, and, based on the total weight of the thermoplastic component, the amounts of EVA-g-MAH and POE were 60 wt % and 50 wt %, respectively. The test results for the thermoplastic elastomer article sample of Example 3 are shown in Table 1.

### Example 4

### Nylon 6: PET: Compatibilizer=85:10:5

The method for making a thermoplastic elastomer article sample of Example 4 was similar to that of Example 1, except that the thermoplastic component was composed of 85 wt % of Nylon 6, 10 wt % of PET, and 5 wt % of compatibilizer, and, based on the total weight of the thermoplastic component, the amounts of EVA-g-MAH and POE were 80 wt % and 70 wt %, respectively. The test results for the thermoplastic elastomer article sample of Example 4 are shown in Table 1.

TABLE 1

| | | Ex- | Ex- | Ex- | Ex- |
|---|---|---|---|---|---|
| | | ample | ample | ample | ample |
| | | 1 | 2 | 3 | 4 |
| Thermo- | Nylon 6 (wt %) | 10 | 30 | 60 | 85 |
| plastic | PET (wt %) | 10 | 10 | 10 | 10 |
| component | Compatibilizer (wt %) | 80 | 60 | 30 | 5 |
| Elastomer | EVA-g-MAH (wt %) | 1 | 40 | 60 | 80 |
| Modifier | POE (wt %) | 10 | 30 | 50 | 70 |
| | Tensile yield strength | 48 | 53 | 60 | 51 |
| | (MPa) | | | | |
| | Elongation at break (%) | 92 | 89 | 85 | 60 |
| | Flexural strength (MPa) | 1424 | 1374 | 1299 | 1297 |
| | Flexural modulus (MPa) | 4021 | 3668 | 3138 | 3884 |
| | Impact strength (J/m) | 87 | 89 | 92 | 85 |
| | Hardness (share D) | 60 | 75 | 80 | 100 |
| | Heat deflection | 70 | 85 | 86 | 101 |
| | temperature (° C.) | | | | |
| | Abrasion resistance (cc) | 15 | 20 | 22 | 32 |
| | Linear expansion | 25 | 22 | 15 | 5 |
| | coefficient | | | | |
| | (1 × 10⁻⁵ cm/cm/° C.) | | | | |

The results shown in Table 1 illustrate that the thermoplastic elastomer article made from the thermoplastic elastomer composition of this invention exhibits good tensile yield strength, heat deflection temperature and linear expansion coefficient. Moreover, the physical properties of the thermoplastic elastomer article can be varied by modifying the proportions of Nylon 6, PET, compatibilizer and EVA-g-MAH.

To sum up, by adding the polyamide and PET into the elastomer, the thermoplastic elastomer article thus made has good tensile yield strength, heat deflection temperature and linear expansion coefficient. Moreover, with the maleic anhydride grafted on the elastomer, the elastomer, the polyamide and PET could be together to form the thermoplastic elastomer article with good physical properties.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A thermoplastic elastomer composition, comprising;
an elastomer; and
a thermoplastic component including polyamide, polyethylene terephthalate and a compatibilizer.

2. The thermoplastic elastomer composition of claim 1, wherein said elastomer includes maleic anhydride grafted elastomer.

3. The thermoplastic elastomer composition of claim 2, wherein said elastomer is selected from the group consisting of maleic anhydride grafted thermoplastic elastomer, maleic anhydride grafted thermoplastic rubber and maleic anhydride grafted rubber.

4. The thermoplastic elastomer composition of claim 2, wherein said maleic anhydride grafted elastomer is selected from the group consisting of maleic anhydride grafted ethylene vinyl acetate, maleic anhydride grafted styrene butadiene styrene block copolymer, maleic anhydride grafted ethylene propylene copolymer rubber and maleic anhydride grafted ethylene propylene diene terpolymer.

5. The thermoplastic elastomer composition of claim 1, wherein said elastomer is present in an amount ranging from 1 wt % to 90 wt % based on the weight of said thermoplastic component.

6. The thermoplastic elastomer composition of claim 1, wherein said compatibilizer includes an epoxy polymer.

7. The thermoplastic elastomer composition of claim 6, wherein said epoxy polymer is selected from the group consisting of epoxy silane resin and alicyclic type epoxy resin.

8. The thermoplastic elastomer composition of claim 1, wherein, based on the total weight of said thermoplastic component, said polyamide, said polyethylene terephthalate and said compatibilizer are present amounts of 10 wt %˜85 wt %, 5 wt %˜15 wt % and 5 wt %˜80 wt % respectively.
